(19) United States
(12) Patent Application Publication
(10) Pub. No.: US 2020/0235361 A1
(43) Pub. Date: Jul. 23, 2020

(54) METHOD OF PRODUCING SEPARATOR, SEPARATOR, AND LITHIUM ION SECONDARY BATTERY

(71) Applicant: Envision AESC Energy Devices Ltd., Sagamihara-shi, Kanagawa (JP)

(72) Inventors: Kento TAKAHASHI, Sagamihara-shi (JP); Fumiaki OBONAI, Sagamihara-shi (JP)

(73) Assignee: Envision AESC Energy Devices Ltd., Sagamihara-shi, Kanagawa (JP)

(21) Appl. No.: 16/486,977

(22) PCT Filed: Jan. 30, 2018
(86) PCT No.: PCT/JP2018/002882

§ 371 Date: Aug. 19, 2019

(30) Foreign Application Priority Data
Mar. 10, 2017 (JP) 2017-046011

(51) Int. Cl. H01M 2/14; H01M 10/0525; H01M 2/16; H01M 2/18

(52) U.S. Cl. CPC H01M 2/145; H01M 10/0525; H01M 2/18; H01M 2/1653; H01M 2/1646; H01M 2/1686

(57) ABSTRACT

A method of producing a separator (20) of the present invention is a method of producing the separator (20) which includes a resin layer (21), and a ceramic layer (23) provided on one surface of the resin layer (21), the method including a step of cutting the separator into a predetermined size by irradiating the separator with a laser having a wavelength of greater than or equal to 300 nm and less than or equal to 600 nm from a side of the ceramic layer (23).

Further, the separator (20) of the present invention includes the resin layer (21), the ceramic layer (23) which is provided on one surface of the resin layer (21), and a curled portion (27) which is formed by curling at least one end portion (25) of the separator (20) toward a surface on a side of the resin layer (21).

### TECHNICAL FIELD

The present invention relates to a method of producing a separator, a separator, and a lithium ion secondary battery.

### BACKGROUND ART

In a lithium ion secondary battery, a porous resin film mainly formed of a polyolefin-based resin or a polyester-based resin is used as a separator. Such a porous resin film has a shutdown function of blocking the flow of a current by fine pores of the porous resin film being clogged in a case where an abnormal current occurs or the temperature of a battery is increased. Therefore, the porous film is considered to be effective from the viewpoint of avoiding thermal runaway of the battery.

As a technique related to such a separator, the technique described in Patent Document 1 is exemplified.

Patent Document 1 (Japanese Unexamined Patent Publication No. 2011-71009) describes a separator for a lithium ion battery which includes a porous resin film; and an insulating ceramic layer provided on at least a first surface thereof.

It is usually considered that such a separator having a ceramic layer is unlikely to be thermally contracted and has excellent heat resistance.

### RELATED DOCUMENT

### Patent Document

[Patent Document 1] Japanese Unexamined Patent Publication No. 2011-71009

### SUMMARY OF THE INVENTION

### Technical Problem

A separator is cut into a shape suitable for insertion into a space between a positive electrode and a negative electrode.

According to the examination conducted by the present inventors, the mechanism described below became apparent.

First, a separator having a ceramic layer typically includes a resin layer such as a polyolefin-based resin layer or a polyester-based resin layer; and a ceramic layer provided on one surface of the resin layer. In a case where such a separator having a multilayer structure is cut by a thermal cutting system such as a thermal cutter or a thermal wire, a heat-resistant ceramic layer is not contracted and a heat-sensitive resin layer is severely contracted. As the result, only the ceramic layer floats, cracks occur in the ceramic layer, and thus ceramic particles fall off in some cases. There is a possibility that the ceramic particles which have fallen off become foreign matter and damage a protective layer formed on the inner surface of an exterior body.

Further, according to the examination conducted by the present inventors, in a case where the separator having a ceramic layer is cut by a force-cutting blade or a rotary blade, the edge of the blade is chipped due to the contact between hard ceramic particles and the blade, and thus the cutting property of the blade is degraded. Accordingly, it became apparent that the degradation of the cutting property may cause a problem of occurrence of burrs or incapability of cutting a separator or may result in degradation of productivity due to an increase in the frequency of blade replacement.

Further, according to the examination conducted by the present inventors, it became apparent that in the separator having a ceramic layer, ceramic particles constituting the ceramic layer are likely to fall off from an end surface thereof.

The present invention has been made in consideration of the above-described circumstances, and an object thereof is to provide a method of producing a separator which is capable of stably obtaining a separator in which occurrence of burrs or cutting powder on a cut surface is suppressed.

Further, another object of the present invention is to provide a separator in which fall-off of ceramic particles from an end surface is suppressed.

### Solution to Problem

The present inventors repeatedly conducted intensive examination in order to solve the above-described problems. As the result, it was found that a thermal effect on a separator having a ceramic layer can be reduced by using a laser with a specific wavelength, the separator can be cut at a low output for a short time by being irradiated with the laser from the ceramic layer side so that the separator is cut into a predetermined size, and thus a separator in which the amount of cutting powder attached to a cut surface is suppressed to be low while suppressing occurrence of burrs on the cut surface is stably obtained.

Further, the present inventors found that in a separator having a curled portion formed by curling at least one end portion of the separator toward a surface on a resin layer side, fall-off of ceramic particles from an end surface is suppressed.

The present invention has been devised based on such findings. In other words, according to the present invention, there are provided a method of producing a separator, a separator, and a lithium ion battery described below.

According to the present invention, there is provided a method of producing a separator which includes a resin layer, and a ceramic layer provided on one surface of the resin layer, the method including: a step of cutting the separator into a predetermined size by irradiating the separator with a laser having a wavelength of greater than or equal to 300 nm and less than or equal to 600 nm from a side of the ceramic layer.

Further, according to the present invention, there is provided a separator including: a resin layer; a ceramic layer which is provided on one surface of the resin layer; and a curled portion which is formed by curling at least one end portion of the separator toward a surface on a side of the resin layer.

Further, according to the present invention, there is provided a lithium ion secondary battery including: a positive electrode which stores and releases lithium; a negative electrode which stores and releases lithium; a nonaqueous electrolytic solution which contains a lithium salt; a separator which is interposed between the positive electrode and the negative electrode; and a container which contains these, in which the separator includes the separator of the present invention.

### Advantageous Effects of Invention

According to the method of producing a separator of the present invention, it is possible to stably obtain a separator in which occurrence of burrs or cutting powder on a cut surface is suppressed.

Further, according to the separator of the present invention, it is possible to suppress fall-off of ceramic particles from an end surface.

### BRIEF DESCRIPTION OF THE DRAWINGS

The above-described purpose and other purposes, features, and advantages will become more apparent based on the preferred embodiments described below and the accompanying drawings.

FIG. 1 is a cross-sectional view schematically illustrating an example of a structure of a separator according to an embodiment of the present invention.

FIG. 2 shows cross-sectional views schematically illustrating an example of a structure of an end portion of a separator according to an embodiment of the present invention.

FIG. 3 is a schematic view schematically illustrating an example of a structure of a lamination type battery according to an embodiment of the present invention.

FIG. 4 is a schematic view schematically illustrating an example of a structure of a winding type battery according to an embodiment of the present invention.

### DESCRIPTION OF EMBODIMENTS

Hereinafter, embodiments of the present invention will be described with reference to the accompanying drawings. In all drawings, the same constituent elements are denoted by the same reference numerals, and the description thereof will not be repeated. Further, the shape, the size, and the positional relationship of each constituent element in the drawings are schematically shown in order to facilitate the understanding of the present invention, and the size thereof is different from the actual size. Further, the numerical ranges “A to B” in the present embodiment indicate greater than or equal to A and less than or equal to B unless otherwise specified.

<Method of Producing Separator>

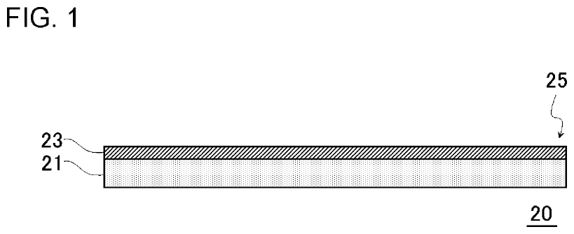

FIG. 1 is a cross-sectional view schematically illustrating an example of the structure of a separator 20 according to the embodiment of the present invention.

The separator 20 according to the present embodiment includes a resin layer 21, and a ceramic layer 23 provided on one surface of the resin layer 21. Further, a method of producing the separator 20 according to the present embodiment includes a step of cutting the separator into a predetermined size by irradiating the separator with a laser having a wavelength of greater than or equal to 300 nm and less than or equal to 600 nm from a side of the ceramic layer 23.

The separator according to the present embodiment can be used, for example, as a separator for a lithium ion secondary battery.

According to the examination conducted by the present inventors, the mechanism described below became apparent.

First, a separator having a ceramic layer typically includes a resin layer such as a polyolefin-based resin layer or a polyester-based resin layer; and a ceramic layer provided on one surface of the resin layer. In a case where such a separator having a multilayer structure is cut by a thermal cutting system such as a thermal cutter or a thermal wire, a heat-resistant ceramic layer is not contracted and a heat-sensitive resin layer is severely contracted. As the result, only the ceramic layer floats, cracks occur in the ceramic layer, and thus ceramic particles fall off in some cases. There is a possibility that the ceramic particles which have fallen off become foreign matter and damage a protective layer formed on the inner surface of an exterior body.

Further, according to the examination conducted by the present inventors, in a case where the separator having a ceramic layer is cut by a force-cutting blade or a rotary blade, the edge of the blade is chipped due to the contact between hard ceramic particles and the blade, and thus the cutting property of the blade is degraded. Accordingly, it became apparent that the degradation of the cutting property may cause a problem of occurrence of burrs or incapability of cutting a separator or may result in degradation of productivity due to an increase in the frequency of blade replacement.

As the result of intensive examination conducted by the present inventors, it was found that a thermal effect on the separator 20 can be reduced, and the separator can be cut at a low output for a short time by irradiating the separator with a laser having a wavelength of greater than or equal to 300 nm and less than or equal to 600 nm from a side of the ceramic layer 23 and cutting the separator into a predetermined size, and thus a separator in which the amount of cutting powder attached to a cut surface is suppressed to be low while suppressing occurrence of burrs on the cut surface is stably obtained.

The reason why the separator can be cut at a low output for a short time by employing the method of producing the separator 20 according to the present embodiment is not clear, but can be assumed as follows.

First, by irradiating the separator with a laser having a wavelength of greater than or equal to 300 nm and less than or equal to 600 nm from a side of the ceramic layer 23, the ceramic layer 23 and the resin layer 21 efficiently absorb the energy and generate heat so that the separator can be cut by the heat. Therefore, it is considered that the separator can be cut at a low output for a short time. In addition, it is considered that the cut surface is not roughened, and occurrence of burrs and the amount of cutting powder attached to the cut surface can be suppressed as the result of the separator being cut at a low output for a short time.

Here, the wavelength of the laser is greater than or equal to 300 nm and less than or equal to 600 nm, but is preferably greater than or equal to 350 nm and less than or equal to 550 nm and more preferably 355 nm or 532 nm from the viewpoint that the separator can be cut at a lower output for a short time. Further, from the viewpoint of low cost, a laser having a wavelength of 532 nm is particularly preferable.

In a case where the wavelength of the laser is set to be less than or equal to the above-described upper limit, the rate of energy to be absorbed on the separator 20 can be increased, and thus the separator can be cut at a lower output for a short time.

Further, in a case where the wavelength of the laser is set to be greater than or equal to the above-described lower limit, since the output of energy can be increased or the laser equipment can be simplified, the separator can be cut more efficiently and the cost can be reduced.

As the laser having a wavelength of greater than or equal to 300 nm and less than or equal to 600 nm, a laser obtained by dividing a YVO4 fundamental wave (wavelength of 1064 nm) or a YAG fundamental wave (wavelength of 1064 nm) into an integral multiple is exemplified. Here, the laser having a wavelength of 532 nm is obtained by converting a YVO₄ fundamental wave (wavelength of 1064 nm) or a YAG fundamental wave (wavelength of 1064 nm) into a laser with a wavelength of ½, and the laser having a wavelength of 355 nm is obtained by converting a YVO₄ fundamental wave (wavelength of 1064 nm) or a YAG fundamental wave (wavelength of 1064 nm) into a laser with a wavelength of ⅓.

The plane shape of the separator 20 according to the present embodiment is not particularly limited and can be appropriately selected depending on the shape of the electrode or the collector. For example, a rectangular shape may be employed.

From the viewpoints of achieving the balance between the mechanical strength and the lithium ion conductivity and improving the energy density of a lithium ion secondary battery to be obtained, the thickness of the resin layer 21 is preferably greater than or equal to 1 μm and less than or equal to 50 μm, more preferably greater than or equal to 5 μm and less than or equal to 40 μm, and still more preferably greater than or equal to 10 μm and less than or equal to 30 μm.

Examples of the resin that forms the resin layer 21 include a polyolefin-based resin such as a polypropylene-based resin or a polyethylene-based resin, and a polyester-based resin such as polyethylene terephthalate, polyethylene naphthalate, and polybutylene naphthalate. Among these, from the viewpoint that the balance between the heat resistance, the shutdown function, and the cost is excellent, a polyolefin-based resin is preferable, and a polypropylene-based resin is more preferable.

Further, in a case where a polypropylene-based resin is used as the resin that forms a resin layer, the separator is highly unlikely to be cut unless the separator is irradiated with a laser at a high output for a long time, and burrs or cutting powder is highly likely to occur at the time of cutting the separator. Therefore, in a case where the resin that forms the resin layer 21 is a polypropylene-based resin, a method of producing the separator 20 according to the present embodiment is particularly effective.

Here, it is preferable that the resin layer 21 contains at least one selected from a polyolefin-based resin and a polyester-based resin as a main component. Here, the “main component” indicates that the proportion thereof in the porous resin layer is greater than or equal to 50% by mass, preferably greater than or equal to 70% by mass, more preferably greater than or equal to 90% by mass, and may be 100% by mass.

The polypropylene-based resin is not particularly limited, and examples thereof include propylene homopolymers and copolymers of propylene and other olefins. Among these, propylene homopolymers (homopolypropylene) are preferable. The polypropylene-based resin may be used alone or in combination of two or more kinds thereof.

Further, examples of olefins to be copolymerized with propylene include α-olefins such as ethylene, 1-butene, 1-pentene, 4-methyl-1-pentene, 1-hexene, 1-octene, 1-nonene, and 1-decene.

The polyethylene-based resin is not particularly limited, and examples thereof include ethylene homopolymers and copolymers of ethylene and other olefins. Among these, ethylene homopolymers (homopolypropylene) are preferable. The polyethylene-based resin may be used alone or in combination of two or more kinds thereof.

Further, examples of olefins to be copolymerized with ethylene include α-olefins such as 1-butene, 1-pentene, 4-methyl-1-pentene, 1-hexene, 1-octene, 1-nonene, and 1-decene.

It is preferable that the resin layer 21 is a porous resin layer. In this manner, fine pores of the porous resin film are clogged so that the flow of a current can be blocked and thermal runaway of the battery can be avoided in a case where an abnormal current occurs in a lithium ion secondary battery or the temperature of the battery is increased.

From the viewpoint of the balance between the mechanical strength and the lithium ion conductivity, the porosity of the porous resin layer is preferably greater than or equal to 20% and less than or equal to 80%, more preferably greater than or equal to 30% and less than or equal to 70%, and particularly preferably greater than or equal to 40% and less than or equal to 60%.

The porosity can be acquired using the following equation.

ε={1−Ws/(ds·t)}×100

Here, represents the porosity (%), Ws represents the weight per area (g/m²), ds represents the true density (g/cm³), and t represents the film thickness (μm).

From the viewpoint of improving the heat resistance, the separator 20 according to the present embodiment includes the ceramic layer 23 on one surface of the resin layer 21.

In a case where the separator 20 according to the present embodiment includes the ceramic layer 23, thermal contraction of the separator 20 can be further reduced and short circuit between electrodes can be prevented.

The ceramic layer 23 can be formed by, for example, coating the resin layer 21 with a ceramic layer-forming material and drying the material. As the ceramic layer-forming material, a material obtained by dissolving or dispersing ceramic particles and a binder in an appropriate solvent can be used.

The ceramic particles used for the ceramic layer 23 can be appropriately selected from known materials which have been used for separators of lithium ion secondary batteries. For example, a highly insulating oxide, a nitride, a sulfide, a carbide, or the like is preferable, and one or two or more ceramics prepared in a particle shape, which are selected from aluminum oxide, titanium oxide, silicon oxide, magnesium oxide, barium oxide, zirconium oxide, zinc oxide, and iron oxide are more preferable. Among these, aluminum oxide and titanium oxide are preferable.

The binder is not particularly limited, and examples thereof include a cellulose-based resin such as carboxymethyl cellulose (CMC); an acrylic resin; and a fluorine-based resin such as polyvinylidene fluoride (PVDF). The binder may be used alone or in combination of two or more kinds thereof.

The solvent in which these components are dissolved or dispersed is not particularly limited and can be used by being appropriately selected from water, alcohols such as ethanol, N-methylpyrrolidone (NMP), toluene, dimethyl carbonate (DMC), and ethyl methyl carbonate (EMC).

From the viewpoint of the balance between the heat resistance, the mechanical strength, the handleability, and the lithium ion conductivity, the thickness of the ceramic layer 23 is preferably greater than or equal to 0.1 μm and less than or equal to 50 μm, more preferably greater than or equal to 1 μm and less than or equal to 30 μm, and still more preferably greater than or equal to 1 μm and less than or equal to 15 μm.

<Separator>

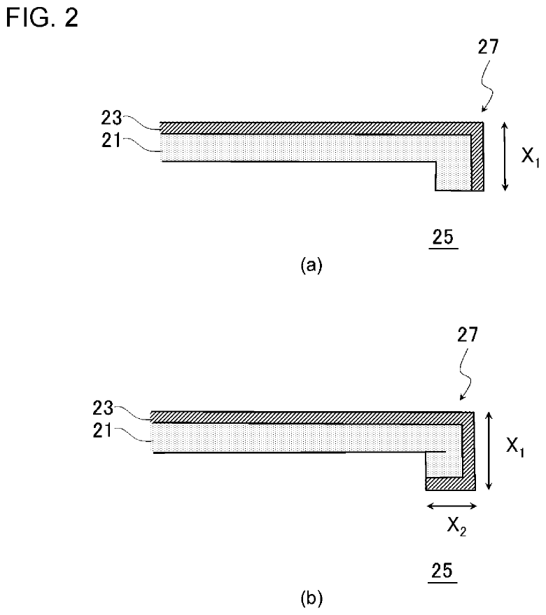

Here, FIG. 2 shows cross-sectional views schematically illustrating an example of the structure of an end portion 25 of the separator 20 according to the embodiment of the present invention.

Further, it is preferable that the separator 20 according to the present embodiment includes the resin layer 21; the ceramic layer 23 which is provided on one surface of the resin layer 21; and a curled portion 27 which is formed by curling at least one end portion 25 of the separator 20 toward a surface on a side of the resin layer 21.

The curled portion 27 may have a structure in which the end portion 25 is bent vertically as illustrated in (a) of FIG. 2 or a structure in which the curled portion 27 is curled in a U shape as illustrated in (b) of FIG. 2.

According to the examination conducted by the present inventors, it became evident that fall-off of ceramic particles constituting a ceramic layer from an end surface is likely to occur in a case of the separator having a ceramic layer.

As the result of intensive examination conducted by the present inventors, it was found that fall-off of ceramic particles from the end surface is suppressed in a case of the separator 20 which includes the curled portion 27 formed by curling at least one end portion 25 of the separator 20 toward the surface on a side of the resin layer 21.

In other words, it was found for the first time that a measure of availability of the curled portion 27 in the end portion of the separator 20 is effective as design guidelines for realizing the separator 20 in which fall-off of ceramic particles from the end surface is suppressed.

The reason why fall-off of ceramic particles is suppressed in such a separator 20 is not clear, but can be assumed as follows. First, it is considered that the separator 20 having the curled portion 27 means a state in which the separator is irradiated with a laser from a side of the ceramic layer 23 and cut at a low output for a short time. In other words, the separator 20 having the curled portion 27 means that the separator is prepared while suppressing the occurrence of burrs on a cut surface or the amount of cutting powder attached to the cut surface, and fall-off of ceramic particles is considered to be suppressed due to the excellent cut surface.

Further, it is considered that fall-off of ceramic particles is suppressed as the result of dissolution of the resin layer 21 due to a small thermal effect so that re-adhesion of the resin layer to the ceramic layer 23 is carried out at the time during which the separator is irradiated with a laser and cut at a low output for a short time.

The curled portion 27 is formed on at least one end portion 25 of the separator 20. However, from the viewpoint of further suppressing fall-off of ceramic particles from the end surface, it is preferable that the curled portion 27 is formed on both end portions 25 of the separator 20.

In the separator 20 according to the present embodiment, the thickness of the curled portion 27 at the time of being stretched is preferably greater than or equal to 30 μm and less than or equal to 300 μm, more preferably greater than or equal to 50 μm and less than or equal to 250 μm, and still more preferably greater than or equal to 100 μm and less than or equal to 200 μm.

Here, in a case where the curled portion 27 has the structure illustrated in (a) of FIG. 2, the length of the curled portion 27 at the time of being stretched indicates a length X₁ in the vertical direction. Further, in a case where the curled portion 27 has the structure illustrated in (b) of FIG. 2, the length thereof indicates the total length of the length X₁ in the vertical direction and a length X₂ of the curled portion 27 in the in-plane direction.

In the separator 20 according to the present embodiment, the length X1 of the curled portion 27 in a direction perpendicular to the in-plane direction of the separator 20 is preferably greater than or equal to 30 μm and less than or equal to 200 μm, more preferably greater than or equal to 40 μm and less than or equal to 150 μm, and still more preferably greater than or equal to 50 μm and less than or equal to 100 μm.

The separator 20 having the curled portion 27 can be obtained using a method of producing the separator 20 according to the present embodiment which includes a step of cutting the separator into a predetermined size by irradiating the separator with a laser having a wavelength of greater than or equal to 300 nm and less than or equal to 600 nm from a side of the ceramic layer 23 described above.

<Lithium Ion Secondary Battery>

A lithium ion secondary battery according to the present embodiment has the following configuration.

The lithium ion secondary battery includes a positive electrode which stores and releases lithium; a negative electrode which stores and releases lithium; a nonaqueous electrolytic solution which contains a lithium salt; a separator which is interposed between the positive electrode and the negative electrode; and a container which contains these, in which the separator is the separator for a lithium ion secondary battery according to the present embodiment.

The form or the type of the lithium ion secondary battery according to the present embodiment is not particularly limited, but can be configured as follows.

[Lamination Type Battery]

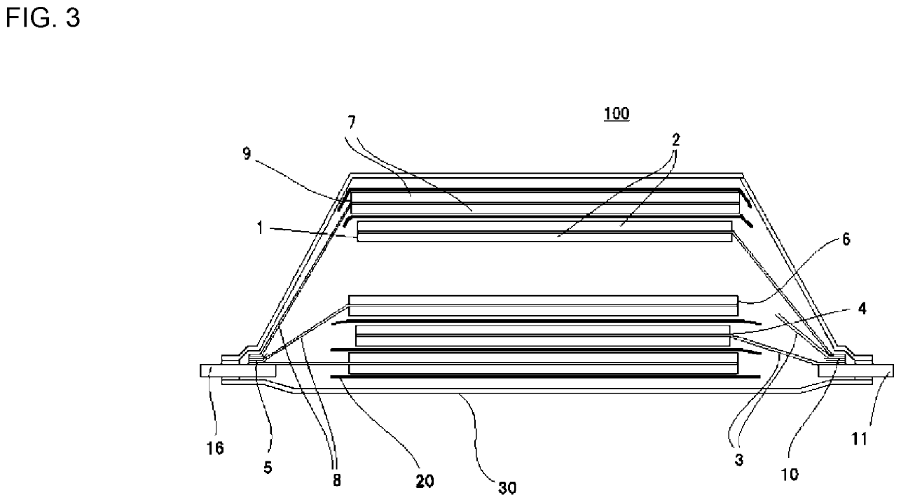

FIG. 3 is a schematic view schematically illustrating an example of the structure of a lamination type battery 100 according to an embodiment of the present invention. The lamination type battery 100 includes battery elements formed by alternately laminating a plurality of the positive electrodes 1 and the negative electrodes 6 through the separator 20, and these battery elements and an electrolytic solution (not illustrated) are stored in a container formed of a flexible film 30. The battery elements are configured such that a positive electrode terminal 11 and a negative electrode terminal 16 are electrically connected thereto and the positive electrode terminal 11 and the negative electrode terminal 16 are partially or entirely drawn out to the outside of the flexible film 30.

In a positive electrode 1, a coated portion 2 and an uncoated portion of the positive electrode active material are respectively provided on the front and rear side of a positive electrode collector 3. Further, in a negative electrode, a coated portion 7 and an uncoated portion of the negative electrode active material are respectively provided on the front and rear side of a negative electrode collector 8.

Positive electrode tabs 10 for connecting the uncoated portion of the positive electrode active material in the positive electrode collector 3 to the positive electrode terminal 11; and negative electrode tabs 5 for connecting the uncoated portion of the negative electrode active material in the negative electrode collector 8 to the negative electrode terminal 16 are provided.

The positive electrode tabs 10 are collectively provided on the positive electrode terminal 11, and the positive electrode tabs 10 and the positive electrode terminal 11 are connected with each other through ultrasonic welding or the like. Further, the negative electrode tabs 5 are collectively provided on the negative electrode terminal 16, and the negative electrode tabs 5 and the negative electrode terminal 16 are connected with each other through ultrasonic welding or the like. Further, one end of the positive electrode terminal 11 is drawn out to the outside of the flexible film 30, and one end of the negative electrode terminal 16 is also drawn out to the outside of the flexible film 30.

An insulation member can be formed at a boundary portion 4 between the coated portion 2 and the uncoated portion of the positive electrode active material as necessary, and the insulation member can be formed not only at the boundary portion 4 but also in the vicinity of both boundary portions of the positive electrode tabs 10 and the positive electrode active materials.

Similarly, an insulation member can be formed at a boundary portion 9 between the coated portion 7 and the uncoated portion of the negative electrode active material as necessary, and the insulation member can be formed in the vicinity of both boundary portions of the negative electrode tabs 5 and the negative electrode active materials.

Typically, the external dimension of the coated portion 7 of the negative electrode active material is larger than the external dimension of the coated portion 2 of the positive electrode active material and smaller than the external dimension of the separator 20.

[Winding Type Battery]

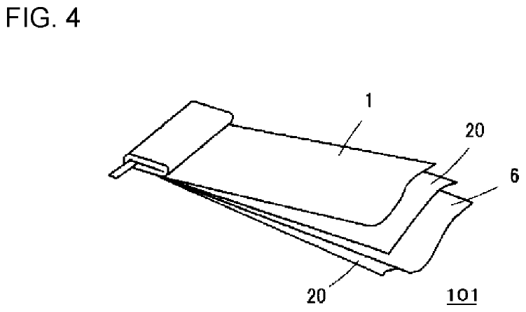

FIG. 4 is a schematic view schematically illustrating an example of the structure of a winding type battery 101 according to an embodiment of the present invention. The winding type battery 101 includes wound battery elements formed by laminating the positive electrodes 1 and the negative electrodes 6 through the separator 20, and these battery elements and an electrolytic solution (not illustrated) are stored in a container formed of a flexible film. Since a positive electrode terminal and a negative electrode terminal are also electrically connected to the battery elements of the winding type battery 101 and other configurations are substantially the same as those of the lamination type battery 100, further description thereof will not be repeated here.

Next, each configuration used for the lithium ion secondary battery according to the present embodiment will be described.

(Positive Electrode Storing and Releasing Lithium)

The positive electrode 1 used in the present embodiment can be appropriately selected from positive electrodes which can be used for known lithium ion secondary batteries depending on the applications thereof. As the electrode material used for the positive electrode 1, a material which is capable of reversibly releasing and storing lithium ions and has a high electronic conductivity so that electron transport is easily carried out is preferable.

Examples of the electrode active material used for the positive electrode 1 include a composite oxide of lithium and a transition metal such as a lithium nickel composite oxide, a lithium cobalt composite oxide, a lithium manganese composite oxide, or a lithium-manganese-nickel composite oxide; a transition metal sulfide such as TiS₂, FES, or MoS₂; a transition metal oxide such as MnO, V₂O₅, V₆O₁₃, or TiO₂; and an olivine type lithium phosphorus oxide.

The olivine type lithium phosphorus oxide contains, for example, at least one element selected from the group consisting of Mn, Cr, Co, Cu, Ni, V, Mo, Ti, Zn, Al, Ga, Mg, B, Nb, and Fe, lithium, phosphorus, and oxygen. In order to improve the characteristics of these compounds, some elements may be substituted with other elements.

Among these, an olivine type lithium iron phosphorus oxide, a lithium cobalt composite oxide, a lithium nickel composite oxide, a lithium manganese composite oxide, or a lithium-manganese-nickel composite oxide is preferable. These positive electrode active materials have a high action potential, a high capacity, and a large energy density.

The positive electrode active materials may be used alone or in combination of two or more kinds thereof.

A binder, a conductive agent, and the like can be appropriately added to the positive electrode active material. As the conductive agent, carbon black, carbon fibers, graphite, or the like can be used. Further, as the binder, polyvinylidene fluoride (PVdF), polytetrafluoroethylene (PTFE), carboxymethyl cellulose, modified acrylonitrile rubber particles, or the like can be used.

As the positive electrode collector 3 used for the positive electrode 1, aluminum, stainless steel, nickel, titanium, or an alloy of these can be used. Among these, aluminum is particularly preferable.

The positive electrode 1 according to the present embodiment can be produced according to a known method. For example, a method of dispersing the positive electrode active material, the conductive agent, and the binder in an organic solvent to obtain a slurry, coating the positive electrode collector 3 with the slurry, and drying the slurry can be employed.

(Negative Electrode Storing and Releasing Lithium)

The negative electrode 6 used in the present embodiment can be appropriately selected from negative electrodes which can be used for known lithium ion secondary batteries depending on the applications thereof. The active material used for the negative electrode 6 can also be appropriately selected from those which can be used for negative electrodes depending on the applications.

Specific examples of the material which can be used as the negative electrode active material carbon materials such as artificial graphite, natural graphite, amorphous carbon, diamond-like carbon, fullerene, carbon nanotubes, and carbon nanohorn; lithium metal materials; alloy-based materials such as silicon and tin; oxide-based materials such as Nb₂O₅ and TiO₂; and composites of these.

The negative electrode active material may be used alone or in combination of two or more kinds thereof.

Further, similar to the positive electrode active material, a binder, a conductive agent, and the like can be appropriately added to the negative electrode active material. As these binders or conductive agents, those which can be added to the positive electrode active material can be used.

As the negative electrode collector 8, copper, stainless steel, nickel, titanium, or an alloy of these can be used. Among these, copper is particularly preferable.

Further, the negative electrode 6 according to the present embodiment can be produced according to a known method. For example, a method of dispersing the negative electrode active material and the binder in an organic solvent to obtain a slurry, coating the negative electrode collector 8 with the slurry, and drying the slurry can be employed.

(Nonaqueous Electrolytic Solution Containing Lithium Salt)

The nonaqueous electrolytic solution containing a lithium salt which is used in the present embodiment can be appropriately selected from known solutions depending on the type of the active material or the applications of the lithium ion secondary battery.

Specific examples of the lithium salt include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiC₄F₉SO₃, Li(CF₃SO₂)₂N, and lower fatty acid lithium carboxylate.

The solvent that dissolves a lithium salt is not particularly limited as long as the solvent has been typically used as a liquid that dissolves an electrolyte. Examples thereof include carbonates such as ethylene carbonate (EC), propylene carbonate (PC), butylene carbonate (BC), dimethyl carbonate (DMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, tetrahydrofuran, and 2-methyl tetrahydrofuran; sulfoxides such as dimethyl sulfoxide; oxolanes such as 1,3-dioxolane and 4-methyl-1,3-dioxolane; nitrogen-containing solvents such as acetonitrile, nitromethane, formamide, and dimethylformamide; organic acid esters such as methyl formate, methyl acetate, ethyl acetate, butyl acetate, methyl propionate, and ethyl propionate; phosphoric acid trimester and diglymes; triglymes; sulfolanes such as sulfolane and methyl sulfolane; oxazolidinones such as 3-methyl-2-oxazolidinone; and sultones such as 1,3-propane sultone, 1,4-butane sultone, and naphthasultone. These may be used alone or in combination of two or more kinds thereof.

(Container)

As the container according to the present embodiment, a known member can be used. From the viewpoint of reducing the weight of the battery, it is preferable to use the flexible film 30. As the flexible film 30, a film configured such that a resin layer is provided on each of the front and rear surfaces of a metal layer serving as a base material can be used. As the metal layer, a layer having a barrier property for preventing leakage of an electrolytic solution or entrance of water from the outside can be selected, and aluminum, stainless steel, or the like can be used. The exterior body is formed by providing thermally fusible resin layers such as modified polyolefin and the like on least one surface of the metal layer, disposing thermally fusible resin layers of the flexible film 30 so as to face each other through the battery element and thermally fusing the periphery of a portion that stores the battery element. A resin layer such as a nylon film or a polyester film can be provided on a surface of the exterior body opposite to the surface where the thermally fusible resin layers are formed.

(Terminal)

In the present embodiment, a terminal formed of aluminum or an aluminum alloy can be used as the positive electrode terminal 11, and a terminal formed of copper, a copper alloy, or obtained by plating copper or a copper alloy with nickel can be used as the negative electrode terminal 16. Each terminal is drawn out to the outside of the container, and a thermally fusible resin can be provided in advance on a site positioned in a portion where the periphery of the exterior body in each terminal is thermally welded.

(Insulation Member)

In a case where an insulation member is formed in the boundary portions 4 and 9 between the coated portion and the uncoated portion of the active material, polyimide, glass fibers, polyester, polypropylene, or those containing these in the configuration can be used. The insulation member can be formed by heating these members to be welded to the boundary portions 4 and 9 or coating the boundary portions 4 and 9 with a gel-like resin and drying the resin.

(Separator)

As the separator, the separator 20 according to the present embodiment is used. The description thereof will not be repeated.

Hereinbefore, the embodiments of the present invention have been described, but these are merely examples of the present invention, and various configurations other than these examples may be employed.

Further, the present invention is not limited to the above-described embodiment, and modifications, improvements, and the like can be made within the range where the purpose of the present invention can be achieved.

### EXAMPLES

Hereinafter, the present invention will be described based on the following examples and comparative examples, but the present invention is not limited thereto.

<Evaluation>

(1) Porosity of Separator

The porosity was acquired using the following equation.

ε={1−Ws/(ds·t)}×100

Here, ε represents the porosity (%), Ws represents the weight per area (g/m²), ds represents the true density (g/cm³), and t represents the film thickness (μm).

(2) Observation of Curled Portion

An end portion of the separator was observed using an electron microscope (SEM) to examine the availability of the curled portion. Further, in a case where the separator had a curled portion, the length of the curled portion at the time of being stretched (the total length of X1 and X2) and the length X1 of the curled portion in a direction perpendicular to the in-plane direction of the separator were respectively observed. Further, the shape of the curled portion was also examined.

(3) Evaluation of Cut Surface (End Surface)

A cut surface (end surface) of the separator was observed using an electron microscope (SEM) to examine occurrence of burrs or cutting powder, and the cut surface was evaluated based on the following criteria.

A: Occurrence of burrs on the cut surface (end surface) or adhesion of cutting powder thereto was not found. Fall-off of ceramic particles was not observed.

B: Occurrence of burrs on the cut surface (end surface), adhesion of cutting powder thereto, or fall-off of ceramic particles was observed.

C: Burrs occurred on the cut surface (end surface), cutting powder was adhered thereto, and fall-off of ceramic particles was also observed.

(4) Cutting Efficiency

The separator was cut by being irradiated with a YVO₄ laser under conditions of an irradiation energy of 3 W and an irradiation speed of 200 mm/s. Next, the cutting efficiency was evaluated based on the following criteria.

A: The separator was able to be cut.

C: The separator was not able to be cut.

### Example 1

A separator (size of 20 cm×20 cm) including a porous resin layer with a thickness of 18 μm and a porosity of 50%, which was formed of a polypropylene-based resin; and a ceramic layer with a thickness of 7 μm, which was formed of aluminum oxide particles and provided on one surface of the porous resin layer was prepared.

Next, the separator was irradiated with a YVO₄ laser having a wavelength of 532 nm, which was obtained by converting a YVO₄ fundamental wave (wavelength of 1064 nm) into a laser with a wavelength of ½, from a side of the ceramic layer, and the separator was cut into a size of 20 cm×10 cm (divided into two), thereby obtaining a separator 1. Each evaluation was performed on the obtained separator 1. The obtained evaluation results are listed in Table 1.

### Example 2

A separator 2 was prepared in the same manner as in Example 1 except that the laser to be applied was changed to a YVO₄ laser having a wavelength of 355 nm, which was obtained by converting a YVO₄ fundamental wave (wavelength of 1064 nm) into a laser with a wavelength of ⅓, and each evaluation was performed on the separator 2. The obtained evaluation results are listed in Table 1.

### Comparative Example 1

A separator 3 was prepared in the same manner as in Example 1 except that the separator was irradiated with a YVO₄ laser from a side of a porous resin layer formed of a polypropylene-based resin, and each evaluation was performed on the separator 3. The obtained evaluation results are listed in Table 1.

### Comparative Example 2

A separator 4 was prepared in the same manner as in Example 1 except that the laser to be applied was changed to a YVO₄ fundamental wave (wavelength of 1064 nm), and each evaluation was performed on the separator 4. The obtained evaluation results are listed in Table 1.

### Comparative Example 3

A separator 5 was prepared in the same manner as in Comparative Example 1 except that the laser to be applied was changed to a YVO₄ fundamental wave (wavelength of 1064 nm), and each evaluation was performed on the separator 5. The obtained evaluation results are listed in Table 1.

TABLE 1

| | Laser | Surface | Availability | Length (X₁ + X₂) | Length X₁ | Shape | Evaluation | |
|---|---|---|---|---|---|---|---|---|
| | wavelength | irradiated | of curled | of curled | of curled | of curled | of cut surface | Cutting |
| | [nm] | with laser | portion | portion [μm] | portion [μm] | portion | (end surface) | efficiency |
| Example 1 | 532 | Ceramic layer | Available | 140 | 70 | U shape | A | A |
| Example 2 | 355 | Ceramic layer | Available | 140 | 70 | U shape | A | A |
| Comparative | 532 | Resin layer | Not available | — | — | — | C | A |
| Example 1 | | | | | | | | |
| Comparative | 1064 | Ceramic layer | — | — | — | — | — | C |
| Example 2 | | | | | | | | |
| Comparative | 1064 | Resin layer | — | — | — | — | — | C |
| Example 3 | | | | | | | | |

This application claims priority based on Japanese Patent Application No. 2017-046011 filed on Mar. 10, 2017, the entire contents of which are incorporated herein by reference.

1. A method of producing a separator which includes a resin layer, and a ceramic layer provided on one surface of the resin layer, the method comprising:
a step of cutting the separator into a predetermined size by irradiating the separator with a laser having a wavelength of greater than or equal to 300 nm and less than or equal to 600 nm from a side of the ceramic layer.

2. The method of producing a separator according to claim 1,
wherein the laser is a laser obtained by dividing a YVO₄ fundamental wave or a YAG fundamental wave.

3. The method of producing a separator according to claim 1,
wherein the resin layer contains at least one selected from a polyolefin-based resin and a polyester-based resin.

4. The method of producing a separator according to claim 3,
wherein the resin layer contains a polypropylene-based resin.

5. The method of producing a separator according to claim 1,
wherein the resin layer is a porous resin layer.

6. The method of producing a separator according to claim 1,
wherein the ceramic layer is formed of ceramic particles.

7. The method of producing a separator according to claim 6,
wherein the ceramic particles contain one or two or more kinds selected from aluminum oxide, titanium oxide, silicon oxide, magnesium oxide, barium oxide, zirconium oxide, zinc oxide, and iron oxide.

8. The method of producing a separator according to claim 1,
wherein the separator is a separator for a lithium ion secondary battery.

9. A separator comprising:
a resin layer;
a ceramic layer which is provided on one surface of the resin layer; and
a curled portion which is formed by curling at least one end portion of the separator toward a surface on a side of the resin layer.

10. The separator according to claim 9,
wherein a length of the curled portion at the time of being stretched is greater than or equal to 30 μm and less than or equal to 300 μm.

11. The separator according to claim 9,
wherein a length of the curled portion in a direction perpendicular to an in-plane direction of the separator is greater than or equal to 30 μm and less than or equal to 200 μm.

12. The separator according to claim 9,
wherein the resin layer contains at least one selected from a polyolefin-based resin and a polyester-based resin.

13. The separator according to claim 12,
wherein the resin layer contains a polypropylene-based resin.

14. The separator according to claim 9,
wherein the resin layer is a porous resin layer.

15. The separator according to claim 14,
wherein a porosity of the porous resin layer is greater than or equal to 20% and less than or equal to 80%.

16. The separator according to claim 9,
wherein a thickness of the resin layer is greater than or equal to 1 μm and less than or equal to 50 μm.

17. The separator according to claim 9,
wherein the ceramic layer is formed of ceramic particles.

18. The separator according to claim 9,
wherein the ceramic particles contain one or two or more kinds selected from aluminum oxide, titanium oxide, silicon oxide, magnesium oxide, barium oxide, zirconium oxide, zinc oxide, and iron oxide.

19. The separator according to claim 9,
wherein a thickness of the ceramic layer is greater than or equal to 0.1 μm and less than or equal to 50 μm.

20. (canceled)

21. A lithium ion secondary battery comprising:
a positive electrode which stores and releases lithium;
a negative electrode which stores and releases lithium;
a nonaqueous electrolytic solution which contains a lithium salt;
a separator which is interposed between the positive electrode and the negative electrode; and
a container which contains these,
wherein the separator includes the separator according to claim 9.
